(19) United States
(12) Patent Application Publication
(10) Pub. No.: US 2013/0199088 A1
(43) Pub. Date: Aug. 8, 2013

(54) LOCALIZED AERATION EQUIPMENT FOR GROWING CHAMPIGNONS AND OTHER CULTIVATED MUSHROOMS AND THE METHOD OF ITS USAGE

(71) Applicant: Kestutis Juscius, Gruzdziu sen. (LT)

(72) Inventor: Kestutis Juscius, Gruzdziu sen. (LT)

(21) Appl. No.: 13/878,984

(22) PCT Filed: May 12, 2011
(86) PCT No.: PCT/IB11/52086

§ 371 Date: Apr. 11, 2013

(30) Foreign Application Priority Data
Oct. 11, 2010 (LT) 2010 083

(51) Int. Cl. A01G 1/00; A01G 1/04

(52) U.S. Cl. CPC A01G 1/001; A01G 1/04
USPC 47/1.1

(57) ABSTRACT

The aim of this invention is a new method of growing champignons and other cultivated mushrooms, comprising of the usage of the shelving system and aeration equipment in order to effectively and equally aerate the compost/substratum and qualitatively/precisely control the temperature on the shelves and their parts. The method of usage of the aeration and management equipment/system integrated into the shelf ensures especially even oxygen supply for the nutrient medium, present on the shelf; very qualitative/precise temperature control not only on the shelf, but also locally in any part of the shelf; extremely high homogeneity control of the nutrient medium; considerably lower electric power consumption during the preparation of the nutrient medium; termination of the anaerobic processes to the minimum in the nutrient material; −10-30% shorter overall cycle of the champignon growing; −10-30% bigger yield collected from the same area; a considerable decrease in the prime cost of the champignons growing. Moreover, this new growing method is nature friendly, as well as it decreases the usage of the fossil fuel. When using this manufacturing method, the manufacture of the substratum is more standardized, less uncontrolled processes are left, the technology of the substratum manufacturing becomes available for every mushroom grower.

### FIELD OF THE INVENTION

This invention pertains to a field of growing champignons and other cultivated mushrooms. The newly proposed method and the equipment for its implementation are to be used for champignons, Oyster mushrooms (Pleurotus ostreatus), Enoki, Bruno Shileji, Maitake, Erengyii, Shi-take and other cultivated mushrooms, which are grown by controlling the oxygen amount and the suitable temperature during the aeration of the compost/substratum (growing medium). This invention is closely related to the equipment and the method intended for the champignons growing.

### BACKGROUND OF THE INVENTION

It is considered that the roots of the champignons growing reach the year 1700, however, the purposeful and deliberate growing of champignons has started in the XIX century in France. Despite the fact that the methods of growing champignons known at that time were not very productive, there was a lack of the material homogeneity in all of the stages of champignon growing, the methods were dangerous because of the bacteria, spores and diseases, as well as were unclean and had a strong unpleasant smell emitted by the compost (champignons growing is a certain way of waste recovery, where the basis of the material for champignons growing is made of horse and chicken manure mixed with straws), nevertheless, this was the very start of growing champignons that induced all further works on developing and improving the process of the champignons growing. The primary system for growing champignons formed in China, but after some time this activity spread to Europe and America. In the end of the XIX century, problems of sterilization of the champignons growing were analysed; in the beginning of the XX century the concept of shelving was created, which became the basis and the standard in the field of growing champignons in America and Europe, while in the year 1970, a technology of fermentation rooms (bunkers) or tunnels was created, which enabled to distinguish the stages of the compost pasteurization and mycelium incubation from the mushroom growing, i.e. pasteurization and incubation of the mushroom substratum was transferred to the separate specially equipped premises. From the year 1970, many patents have appeared, which analyse and solve problems occurring in different stages of the champignons growing, however, these were more quantitative improvements of the champignons growing, due to which the yield of mushrooms increased from 22 to 40 kg per one square metre, while the manufacturing process basically remained the same, because the same equipment, i.e. its productivity and efficiency, was improved. It is necessary to emphasize that there are various problems related to the champignons growing: complicated biochemical reactions and uncertainties, because the process of the champignons growing depends on many known and unknown factors. The laboratory findings show only the main qualitative indicators of the substratum; however, usually the findings that correspond to the norms do not ensure that the expected yield will be gained on the prepared substratum. The manufacturer/grower has to take into consideration the colour, smell, decay rate and many other measurable and hardly measurable parameters, the knowledge of which is collected/formed over a long time. For this reason, more and more manufacturers of the mushroom compost and growers of the final product all over the world specialize in one certain activity they know best.

Normally, the champignons growing comprises of 5 stages. In every stage of the champignons growing different problems occur, therefore already existing patents describe and solve problems of various types. Many patents are related to invention of the additional elements/supplements, their manufacturing and method of usage with the aim to enrich the substratum medium with various materials, allowing increasing the amount of the collected mushroom yield.

There is a known U.S. Pat. No. 3,942,969, published on 9^{th} of March of 1976. This patent analyses the nutrient medium, where the mycelium is placed. This patent studies the materials nurturing the mycelium and which are artificially enriched with denaturalized proteins. The mentioned denaturalized proteins are mixed with the substratum before or after planting the mycelium. Vegetable or fish oils are also added for the stronger effect. This invention is intended only for improving/enriching the nutrient medium with the nutrients. However, it involves only a narrow part of the process of the champignons growing and does not analyse the stages/phases of nutrient formation, pasteurization and conditioning (preparation).

The other known U.S. Pat. No. 4,990,173, published on February 5^{th} of 1991. This patent uses hydrophilic carbohydrate materials, which from one side nurture the mycelium network and from the other side restrict the reproduction of the microorganisms and their access to the mycelium networks. This patent analyses the formation process of the nutrient of the champignons in respect of the energy accumulation and the microorganisms, however, it does not include any of the problems related to the formation of the substratum, aeration and temperature control.

There is a known Korean patent No. KR20070078545, published on August 1^{st} of 2007. This patent describes the aeration system of the compost, comprising of ventilators that supply air flow to the room and ventilate the room, where the preparation of the substratum is in the process. During the process of aeration, the oxygen of the compost is controlled in the outer layers of the compost, however, this involves only the outer layers, because the problem of temperature and the amount of oxygen control still stays in the inner layers of the compost.

The closest patent according to the prior art is European patent EP0434159, published on June 26^{th} of 1991. This patent describes a so-called system of tunnels/bunkers, which allows distinguishing the stages of compost pasteurization and mycelium incubation from the mushroom growing. However, a few problems exist in these types of tunnels. One of the problems is very high electric power consumption for ventilation, because the layer of the prepared material is very thick (up to 4 metres). The other problem is not equal oxygen distribution in such tunnels. This happens due to a very big compost loading height and the formation of a very high-density material places in some places and the slots in the other places through which too much of air flows. Due to the mentioned locally formed places of too high or too low density, the material homogeneity in the whole mass of the substratum is not reached.

It is necessary to emphasize that the technologies of the champignon growing have a few very important problems, which have not been solved in the world till these days: temperature and/or aeration control in all/various stages/phases of the champignons growing as well as high electric power consumption for the preparation of the substratum medium and maintaining the current temperature in the room. On one hand, since the natural biochemical reactions are faced, during which a lot of heat energy is emitted, an equal excessive heat abstraction is one of very important aspects. On the other hand, anaerobic and aerobic processes are naturally happening in the prepared material and in the technology of the champignon growing only aerobic processes are required, while anaerobic ones are especially undesirable.

For the aerobic processes to be fluent and anaerobic processes not to happen, an efficient amount of oxygen is to be ensured in the prepared material not only generally (i.e. externally), but also locally, i.e. oxygen distribution is very important in all prepared material. Because in the places, where the lack of oxygen exists, anaerobic processes emerge immediately, inducing decay and rapid reproduction of unwanted microorganisms.

A basically new method of growing champignons and other cultivated mushrooms, comprising of the needed equipment and its usage, is described below. This manufacturing method effectively solves the previously mentioned problems of aeration, temperature and material homogeneity control as well as significantly reduces electric power consumption.

When using this method of manufacturing/growing of champignons, the time needed for growing shortens, the production amount increases and therefore decreases the prime cost of the final product (mushrooms). The problem of harmful microorganisms also decreases, whereas an additional/specialized usage of this method allows saving on electric power. When using this new method of manufacturing, the manufacturing of the mushroom substratum becomes more standardized, less uncontrolled processes are left, the technology of substratum manufacturing becomes available to every mushroom grower. This technology is especially important in respect of ecology—there is a significant decrease in electric power needed for growing one kilogram of mushrooms and it is possible to refuse from using the fossil fuel, because it is possible to use the heat emitted during the preparation process of the substratum. However, currently working plants manufacturing the substratum for the champignon growing simply emit the excess heat into the atmosphere, and, at the same time, the growers burn fuel for maintaining the temperature in the premises, where the mushrooms are grown.

### SUMMARY OF THE INVENTION

The aim of this invention is to create a new method of growing champignons and other cultivated mushrooms, comprising of the corresponding equipment and its usage.

The essential feature of this invention is that it is refused to use the previously mentioned tunnel technology in the process of the champignon growing and is returned to the shelving system, however, it is proposed to grow mushrooms in a completely different way than it used to be done before, i.e. to integrate very effective localized aeration systems, which could very effectively locally and equally aerate the compost/substratum on the mentioned shelves, to the shelves for mushrooms growing filled with compost or substratum. Moreover, together with the air this integrated aeration system abstracts the excess heat, and, when using the system of this type, it is possible to qualitatively/accurately control the temperature. Furthermore, there is a possibility to precisely control the temperature in the room not only externally (as it was done in the prior art), but internally—on the shelves and/or their parts.

This localized aeration and control equipment/system integrated into the shelf, as well as the method of its usage ensure:

completely equal oxygen supply to the nutrient medium (on the shelf) (locally and generally);

very qualitative/precise temperature control not only on the whole shelf, but also in every part of the shelf (currently, the temperature control of the compost in the growing chambers is implemented only externally—by observing and changing the parameters of the environment air);

extremely high homogeneity control of the nutrient medium (when the qualitative air supply and qualitative/precise temperature control are ensured, the compost quality and homogeneity also significantly increase);

significantly lower electric power consumption during the preparation of the nutrient medium, especially in the pasteurization and mycelium incubation stages;

suspension of the anaerobic processes to the minimum in the nutrient material;

˜10-30% shorter overall growing cycle of the champignons;

˜10-30% bigger yield from the same area;

significant reduction of the prime cost of the champignons growing (no need to transport the substratum from the distant plants of the prepared substratum, the usage of the secondary heat emitted by the compost allows reaching 20-40% lower prime cost);

Moreover, this new method of growing allows protecting the nature and its recourses: it significantly reduces the usage of the fossil fuel. The usage of this method allows not only to save on electric power, but also to make biofuel from the mushroom substratum after the yield picking. This substratum can be used for biopower plants and boiler-rooms. When using this method of manufacturing, the production of mushroom substratum is more standardized, there are less uncontrolled processes left, the technology of the substratum manufacturing becomes available for every mushroom grower.

### BRIEF DESCRIPTION OF THE DRAWINGS

FIG. 1 shows an overall schematic view of the localized aeration shelving system for the champignons and other cultivated mushrooms growing.

FIG. 2 presents an overall schematic view of one way of the localized aeration system implementation, where the localized aeration of the processed material is performed from the bottom to the top.

FIG. 3 shows one more schematic view of the ways of the localized aeration system implementation, where the local aeration of the processed material is performed from the inside to the outside.

### DESCRIPTION OF THE PREFFERED EMBODIMENT

Presently, the process of the champignon growing consists of five phases/parts: preparation of the primary compost mass (phase I), compost pasteurization and formation of the prepared nutrient medium (phase II), mycelium germination, incubation (phase III), formation of the rudiments (phase IV) and mushroom growing (phase V).

The primary compost mass is prepared during the phase I. The basis of the mass is made of the materials of an organic origin, for example, horse manure and/or chicken (bird) droppings mixed with straws and water. Additionally, the mineral calcium additives are mixed. Other minerals of the above mentioned materials normally exist in sufficient amounts. Everything is mixed and this mixed mass is placed into the compost piles having a form of a prism or into special premises—bunkers (tunnels), where the compost is made by naturally supplying oxygen to the piles having a form of a prism or by using the forced method in the tunnels/bunkers.

The compost is pasteurized in the beginning of the phase II. High temperature of 56-60° C. degrees together with the ammonia emitted during the process of compost destroys the pathogenic mushrooms and microorganisms, however, useful microorganisms are preserved during this process. Useful microorganisms preserved after pasteurization (thermophilic fungi are the most useful) reproduce in the optimal temperature of 45-50° C. degrees, and they process the materials of the compost and form the optimal medium for the further reproduction of the champignons mycelium.

During the phase III, the mycelium is germinated and incubated into the prepared nutrient medium, while during the phase IV, the rudiments are formed and during the phase V, the final product (champignons) are grown and the production is picked.

Up to the year ˜1970, the mentioned phase II was implemented on the so-called growing shelves (containers, boxes), which were placed into a room ventilated with the outside air. However, the external ventilation of this type was not sufficient and the nutrient medium after the phase II was not of the best quality in respect of the material homogeneity and cleanliness (microorganisms). Since the processes of the champignons growing are related to many various problems, complicated biochemical reactions and uncertainties, more and more manufacturers of the mushroom substratum and the manufacturers of the final product specialize in one particular activity that they know best, i.e. after the year 1970, when the new tunnel systems were presented, works related to the champignons growing were redistributed: phases I and II were implemented in separate rooms (later the phase III—incubation phase—was moved to the tunnels) and phases III, IV and V—in other owned premises, the distance between two of those could reach thousands of kilometres. However, the tunnel systems solved only some of the problems. Furthermore, during passed ˜40 years, many improvements were made, intended for improving the parameters of the separate growing phases and the process effectiveness, however, many patents are not intended for improving the whole process of champignon growing as an integrated system. The essential feature of this invention is that the whole system of the champignons growing (all five phases) is analysed as an integral system, where all growing phases are implemented in one place, i.e. it is refused to use the mentioned tunnel technology and returned to the shelving system, however, it is proposed to grow mushrooms on the shelves (in the boxes, containers, packages, package systems or containers of other type) with integrated/connected effective localized aeration and temperature control system, allowing to ventilate the formed mass from the inside. The essence of the new champignon growing method is to ensure an effective localized aeration, qualitative localized temperature control as well as to create and maintain the homogeneity of the nutrient medium. This invention can also be used for every separate manufacturing phase: in a certain phase, according to the typical processes and technologies, it is necessary to choose and arrange the equipment and its technical parameters.

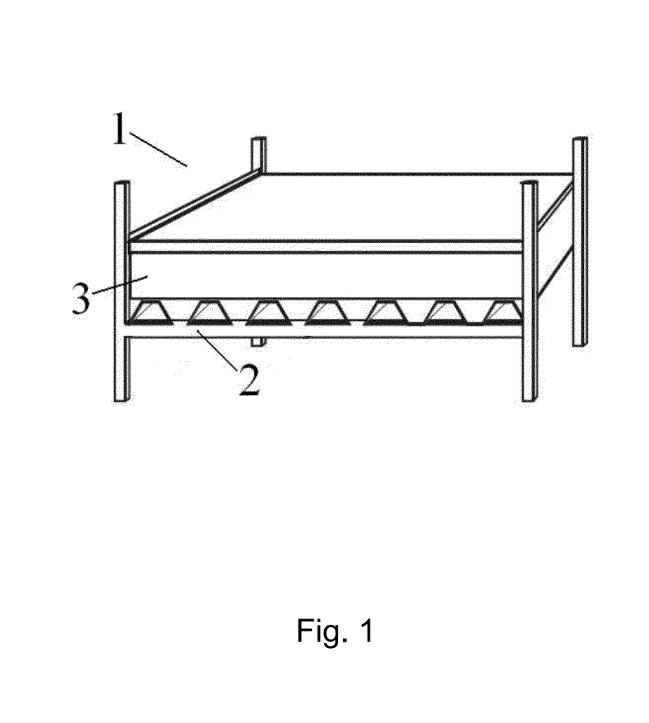

FIG. 1 shows an overall schematic view of the localized aeration shelving system intended for growing champignons and other cultivated mushrooms. The localized aeration shelving system (1) consists of: shelving construction (2), where the processed material (3) is placed, and the localized aeration system (4) with a ventilated bottom (5). This bottom (5) can also be called ventilating, because it is a part of the circuit, ensuring the localized aeration of the mentioned processed material (3).

The processed material (3) can be compost, substratum or other material used in the process of the champignons growing/manufacturing. Depending on the growing stage/phase, the processed material (3) is to be properly locally aerated (processed). To reach this aim, the shelving construction can be used, ensuring the placement of the processed material (3) and the localized aeration. The basis of the shelving construction is made of the ventilated bottom (5) of any form (flat, concave, convex, of a regular or not regular form and etc.). The localized aeration system (4) is integrated into the shelving construction (2), providing an opportunity to ensure an effective localized aeration and qualitative localized temperature control. The processed material (3), which should be properly processed/prepared (depending on the manufacturing phase) is filled on the localized aeration system (4). The localized aeration system (4) is made of the ventilated bottom (5) of one or another construction to which the air is supplied or through which the air is extracted. The construction of the ventilated bottom (5) consists of the aeration elements (6), pipe system (7) and external air supply/extraction system, ensuring the air supply/extraction to/from the pipe system (7). The construction of the ventilated bottom (5) allows proportional and equal distribution of air, oxygen or gas of other consistence in the lower part and in the inside of the compost/substratum. When using the aeration system in the extraction mode, it is possible to easily remove the emitted gas from the compost/substratum straight from the centres (places), where they form.

Aeration elements (6) connected with the ventilated bottom perform the direction of the distributed air flow to/from the processed material or to/from the separate parts of the processed material. When using the ventilated bottom (5), air flows are directed from the bottom to the top at the 90° angle or at other technologically implemented angle.

Depending on the growing method and the type of mushrooms, the extraction process can be implemented by using different methods; the essential aspect is that the air moves/is extracted from the room through the compost/substratum to the localized aeration system.

The amount of the supplied/extracted air depends on the need of the process and differs in various manufacturing phases. The basis of the localized aeration system (4) can be made of the aeration elements of any type or form: the most important thing is that the purpose of them is not aeration of the room, but localized aeration of the mentioned shelving construction (2) or part of the shelving construction (2). The mentioned shelving construction (2) can be a box, container, package for the substratum medium or container of the other type, in which the ventilated bottom could be installed and the required amount of substratum could be placed.

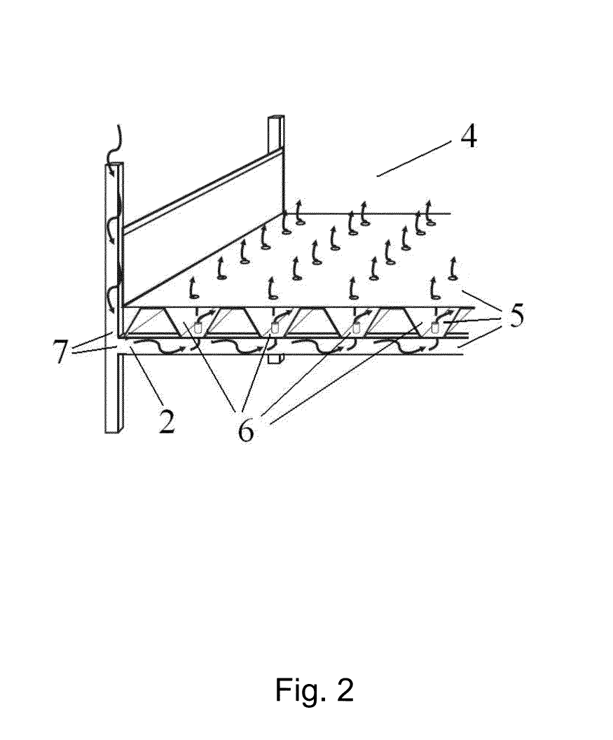

FIG. 2 shows a more detailed schematic view of the localized aeration shelving system (1) intended for growing champignons or other cultivated mushrooms, where one of ways of the localized aeration system (4) implementation is provided, when the aeration of the processed material (3) is implemented from the bottom to the top.

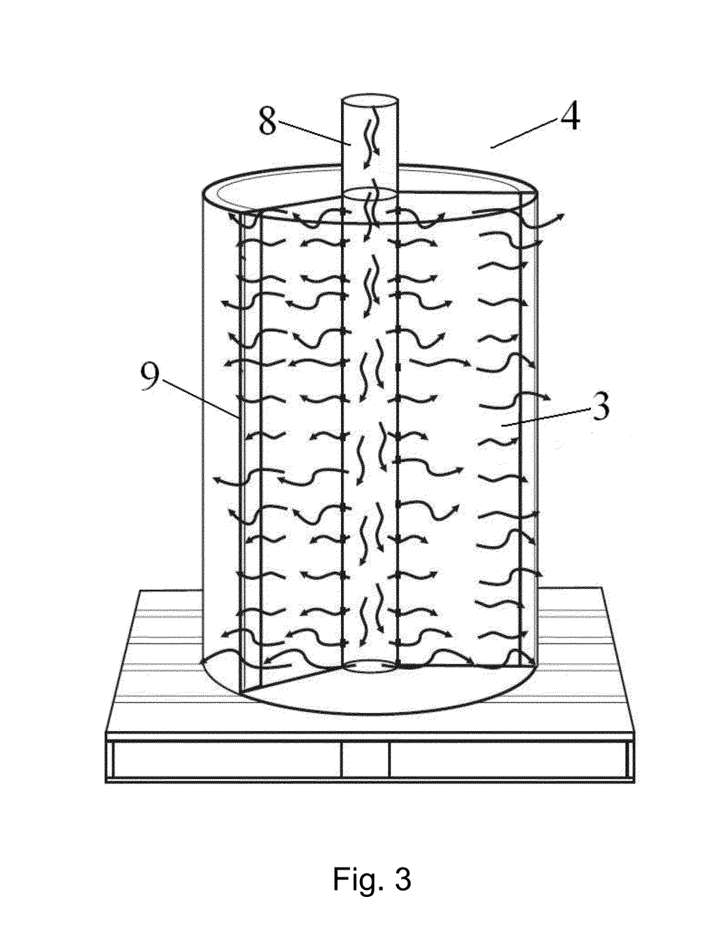

However, the substratum aeration can be performed not only from the bottom to the top, but also in any other way depending on the technical capabilities and if is a sufficient ground for doing that, for example, from the inside to the outside or vice versa. I.e. geometry of the aeration system (4) can be different, it is important for it to be effective, practical and safe. FIG. 3 shows one more way of the localized aeration system (4) implementation, when the processed material (3) aeration is implemented not from the bottom to the top, but from the inside to the outside. In this case, the aeration element having a form of a pipe is mounted into the formed mass (3) of the substratum/compost, through which the supplied/extracted air, which gets inside the processed material (3), comes from the inside to the outside or vice versa. The mentioned aeration element (8) having a form of a pipe can be arranged in different ways, for example, vertically, horizontally or in the other way. The package of the substratum can be made of the air permeable mesh (9). Moreover, the mentioned package can be not air permeable, however, in this case, after packaging, the corresponding vents are formed intended for air extraction/intake from the package/to the package.

Under the same environmental conditions, by changing the amount of the supplied/extracted air and differently ventilating the shelves in the growing room, it is possible to anticipate or slow the manufacturing processes in the localized aeration shelving system. This provides an opportunity to get a more even yield in the room. In the more ventilated places of the shelf, the substratum temperature is lower, therefore on these shelves the mushrooms start growing later comparing to the shelves that are less ventilated and where the temperature remains higher. For this reason the grower will have a bigger amount of the grown production. This is especially important for the growers, who do not have a lot of rooms; however, normally it is important for all growers. The mentioned aeration also ensures a qualitative/precise temperature control. From one side, during aeration the heat can be locally abstracted together with the supplied/extracted and outgoing air. From the other side, depending on the need, the supplied/extracted air can be heated by the additional heating equipment or the same excess heat of the biochemical reactions, emitted in the first and the second phases of the champignons compost manufacturing.

The usage method of the above mentioned system (1) of the shelves (and other similar alternative analogues) with an integrated localized aeration system (4) strongly effects the whole process of the champignons or other cultivated mushrooms growing, starting with the primary stages of the compost processing and finishing with the final product growing.

During the phase I, when the primary compost mass is prepared, the mentioned localized aeration system (4) is essential, because only effective aeration of the compost stops the unwanted anaerobic processes and induces/promotes the aerobic processes, which are important during the whole process of the champignon growing, especially in the preparation, pasteurization and mycelium germination stages. By ensuring a constant air circulation, it is possible to reach a very even composting process in the compost mass during the phase I.

For this reason is it possible to stop using the currently used compost mixing procedure, which is applied with the aim to ensure a better homogeneity of the mixed material. Presently, to ensure an equal fermentation process, the compost is mixed/used 2-6 times during the phase I of the compost manufacturing. During the phase II, when the processes of the pasteurization and the nutrient medium formation are active, the role of the aeration system is to maintain the wanted/required medium temperature, which should be close to the optimal temperature, typical to the corresponding process. When using the method of the localized aeration during the champignons growing, it is possible to shorten the time of the phases I and II from 13-28 to 10-15 days. It is also possible to avoid the anaerobic processes, which ensure the preparation of clean and homogeneous nutrient medium from the very start of the manufacturing process.

Starting with the mycelium planting stage (phase III) and finishing with the final product growing (phase V), aeration and temperature control play important role as well, for example, during the mycelium planting (phase III) and formation of the rudiments (phase IV), a significant amount of heat is emitted, which is to be strictly controlled. When using the method of the localized aeration, this task is easily implemented and the cycle of the mushroom growing from mycelium incubation to yield picking (three growing stages) shortens from 6 to 5.5 weeks. The growing cycle shortens, because after putting the coating layer on the shelf, the mycelium has to naturalize in it and only after this it is possible to move to the fourth phase of the rudiments formation. Since the substratum is ventilated from the inside (i.e. locally), the heat is extracted through the coating layer and its temperature is 2-5° C. higher comparing to the usage of the standard method of growing. For this reason the mycelium naturalizes faster in the coating layer. When using this invention, it is possible to place a bigger amount of compost, which provides a shelf with an additional activeness easily controlled by the aeration systems, influencing a faster formation of the rudiments and the rate of the production growing.

The usage of this localized aeration method allows to place 20-40% bigger amount of dry materials into the same unit of the growing area; therefore it is possible to collect 10-30% bigger yield from the same area. In the currently used technologies of the champignons growing, the increase of compost amount is restricted by the heat emitted by the compost during the mycelium growing: when increasing the compost amount, it is impossible to control the temperature in it; therefore, when increasing the compost amount, the mycelium is destroyed or weakened due to the heat, and usually the opposite (negative) result is reached.

Since the compost temperature is controlled by blowing/extracting the air from the inside and not by cooling with the air of the growing room externally, therefore the temperature of the air for maintaining the compost temperature can be higher. In many cases, it is possible to reach this without using the cooling machines, but by using the outside air, supplied to the mentioned shelves, depending on the blowing or extraction mode, from the bottom or from the top. For example, the same compost temperature of 25° C. can be reached by the standard way of blowing the air of 12° C., which warms up to 17° C. due to the compost, to the room, therefore the cooling effect is the difference of the temperature 25-17, or by supplying the air of 17° C., which is outlet from the compost warmed up to 23-25° C., directly to the compost via the aeration system. Analogically, when using the extraction mode, the air of 17° C. is supplied to the room and extracted when its temperature reaches 23-25° C. When blowing the air from the outside to the compost, it is possible to use the outside air for the heat (present inside the compost) abstraction much more often and use less of expensive cold, generated for air cooling machines.

When using the aeration system in the extraction mode, the heat and gas emitted from the substratum are concentrically collected from their emission centres (places). The heat of the compost/substratum and the emitted gas hardly get into the air of the room, therefore the ventilation systems of lower capacity are enough for the ventilation of the room air. Moreover, in order to provide the optimal development conditions for the mushrooms, the required CO₂ gas concentration is to be maintained in the mushroom growing premises, the value of which, depending on the growing conditions, can differ. Normally, the average outside air CO₂ concentration is approximately 350 ppm, however, due to the biochemical reactions in the mushroom growing premises the concentration of these gas is always higher, therefore, when externally ventilating, every cubic metre of the fresh air decreases CO₂ concentration in the air of the room. In case the air is extracted via the aeration system, in this extracted air CO₂ concentration is always higher than in the room, because the bigger part of the gas does not get into the room and does not mix with the fresh air and is collected and removed via the aeration system. In this case, the smaller amounts of the prepared fresh air are needed for maintaining the same CO₂ level in the air of the growing room, as well as less energy is needed for preparing this air for a certain process/stage of the mushroom growing.

Moreover, the usage of the localized aeration method considerably reduces the prime cost of the champignons growing: it is not necessary to transport the substratum from the substratum factory to the mushroom growing place (the distance between the factories can sometimes reach thousands of kilometres); the raw material is usually obtained locally or manufactured by the person himself, by using all benefits provided by the localized aeration system, because the current price of the substratum makes 50% of the prime cost of the final product.

Comparing to the standard currently known system for the champignon growing, the usage of the localized aeration system and compost heat emitted due to the biochemical reactions, used for heating of the premises, allows reducing the prime cost of the final product (champignons) by 20-40%. By implementing the absorption cooling method it is possible to convert the excess heat into cold, which is necessary during the process of the mushroom growing.

This growing method is also very beneficial in the environmental aspect: there is a considerable decrease in the need for electric power required for growing one kilogram of mushrooms and it is possible to stop using the fossil fuel used for heating the premises. When using the localized aeration system, the substratum left after the mushroom growing can be dried, and the hot air used for the substratum drying is obtained from the residual heat emitted from the substratum during the manufacturing phases 1 and 2. The dried substratum can be used as biofuel for generating heat and electric power. All heat emitted during the manufacturing process is used in this way. The mushroom growing place becomes not only a business entity providing itself with the heat or cold (when the absorption cooling method is used), but also producing additional biofuel for other consumers of the heat. In the contemporary systems of the mushroom growing, the processes of the substratum manufacturing and mushroom growing are distinguished geographically, therefore the heat transfer from the substratum factory to the growing place is impossible. Moreover, when drying the substratum externally with the air of the premises and not blowing/extracting the hot air from the inside via the aeration system, the drying process would take 2-3 times longer, more energy would be used and it would be uneconomic.

When using this invention, the manufacturing of the mushroom substratum is more standardized, there are less uncontrolled processes left, the technology of the substratum manufacturing becomes available to every mushroom grower. The mushroom grower would create a higher added value. In the places, where the mushroom growing is not developed and there is no substratum and no manufacturing rooms with complex technologies and equipment, it is possible to establish new and effectively working factories of the mushroom growing. Since it is not necessary to invest in the specialized equipment for the substratum manufacturing, it can be implemented in the same growing place.

This invention provides significant opportunities not only for growers of the champignons, but also for growers of the other cultivated mushrooms. For example, the previously mentioned localized aeration system (4) can be used for growing Enoki, Bruno Shimeji, Maitake, Erengyii, Shi-take and other mushrooms, during the growing of which substratum pasteurization is needed. The biggest influence this technology makes on the preparation of the substratum. In the currently known technologies the substrata are prepared not in the premises for the mushroom growing. The technologies of substrata sterilization or pasteurization are used to destroy the pathogens. During these processes, the substrata are placed into the special pasteurization premises or autoclaves, where substratum pasteurization or sterilization is implemented. After the mycelium incubation, the substratum is placed into the incubation or growing premises for the mushroom growing. To ensure these processes a special equipment of substrata packaging to the containers or packages is needed. Furthermore, these processes shall be implemented under very sterile conditions. This invention improves substratum pasteurization, because the heat necessary for the pasteurization together with equally supplied/extracted air pass through the substratum mass. The substratum warms up faster and more gradually, considerably less cold non-pasteurized zones occur.

The substratum can be pasteurized in the growing premises. After pasteurization, both the room and the substratum are clear, protected from diseases and pathogens: the only thing to do is to mix the mycelium in the pasteurized medium. For example, when producing Oyster mushrooms (Pleurotus Ostreatus), the previously mentioned tunnel technology is used, when the substratum pasteurization and/or conditioning is implemented in the aerated mass, after pasteurization the substratum is mixed with the mycelium and placed to the packages, which are transported to the premises for mycelium incubation, yield collection or other premises used/assigned for growing.

During mycelium incubation, a lot of heat is emitted, which is controlled externally, by the environment air. Since the intensity of the mycelium growing in the packages is not equal, the temperature in the packages differs and maintaining the optimal temperature needed for incubation process is not an easy task. When using this invention, it is possible to place the substratum immediately (before pasteurization) into the growing premises on the aerated shelves (or other suitable containers) and perform the pasteurization, conditioning and mycelium incubation processes, to make the fruits and grow the yield. Due to the thinner aerated layer (in the tunnels this thickness reaches 4 metres, on the shelves—up to 0.5 metres), the process is better controlled than in the tunnel technology: it is not necessary to place the substratum into packages, it is straight on the growing shelf or other suitable container. Since the substratum after pasteurization is not packaged or transported, the risk of infection reduces. For this reason, more stable yield is obtained. The process of the mycelium incubation is significantly more qualitative, whereas it is possible to control the oxygen concentration not only in the room, but also inside the substratum. Considerably more equal optimal temperature is maintained in the substratum. Since special machines and equipment for substratum packaging and pasteurization are not necessary, every mushroom grower will be able to make the substratum himself, in this way considerably decreasing the prime cost of the final product.

For the substratum preparation, by using the method of growing in the ventilated substratum packages, as shown in FIG. 3, the prepared processed material (3) is formed and placed into packages. During or after packaging, when placing the aeration element (8), through which the air is supplied from the ventilation system (in this case, the general standard ventilation system of the premises can be used) to the package, the substratum is pasteurized by blowing the air of a corresponding pasteurization temperature. Therefore, an equal temperature is reached and maintained in all areas (zones) of the package. After the substratum pasteurization, the mycelium is undersown into the substratum, which, for example, can be injected by the injection method.

The package is ventilated during the mycelium incubation, therefore an equal temperature is ensured in its capacity (mycelium mass). When the mycelium naturalizes, new fruits are made and grown on the external layer of the package. In this particular case, even special shelves are not necessary, the substratum is prepared and the yield is collected simply on the ventilated package of the substratum. When using this technology, optimal mushroom growing conditions are reached, it is not necessary to invest in the expensive special tunnel and/or sterilization premises.

With the aim to illustrate and describe this invention, descriptions of the most suitable ways of implementation are presented above. This is not a comprehensive or restrictive invention aiming for identifying an exact form or way of implementation. The previously presented description has to be seen as an illustration and not as a restriction. It is obvious that many modifications and variations can be obvious for the specialists of this field. Ways of implementation are chosen and described so that the specialists of the field could better explain the principles of the invention and the best practical application for different implementation ways with different modifications, suitable for a certain usage or application. It is foreseen that the scope of this invention is defined by the added claims and the equivalents, where all mentioned terms have meaning in the broadest range, unless it is indicated otherwise. It is to be certified that in the ways of implementation, described by the specialists of that field, the modifications can be made not deviating from the scope of this invention, as it is indicated in the claims provided further.

1-8. (canceled)

9. A champignon growing system consisting of:
processed material,
shelving construction,
control unit and
aeration system,
wherein the champignon growing system has the active localized aeration shelving system (1),
intended for the active localized aeration of the processed material (3) in all champignon growing stages, which require aeration procedure, comprising of:
the processed material (3), which, depending on the growing stage/phase, needs to be locally aerated;
shelving construction (2), adjusted and ensuring the placement of the processed material (3) as well as its localized aeration; and
active localized aeration system (4), ensuring the active localized aeration of the processed material (3) from the bottom;
where:
the processed material (3) is the compost, substratum or other material used in the process of the champignon growing;
shelving construction (2) connected to the pipe system (7) or other system, having the features of ventilation and air/gas supply;
active localized aeration system (4), ensuring the active localized aeration from the bottom of the mentioned processed material (3), consists of:
the mentioned pipe system (7), ensuring the supply of the controlled air/gas flow to the shelving construction (2) or flow extraction from the shelving construction (2);
ventilated bottom (5), integrated into the shelving construction (2), which ensures the active localized distribution of the air flow, oxygen flow or flow of gas of other consistence (for example: air enriched with useful thermophilic fungi or with other useful microorganisms) and the supply of these distributed localized flows to the processed material (3) or flow extraction from the processed material (3);
aeration elements (6), connected to the ventilated bottom, which locally directs
(pushes) the distributed air flow/oxygen flow or flow of the gas of other consistence (for example: air enriched with useful thermophilic fungi or with other useful microorganisms) from the pipe system (7) to the processed material (3) or separate parts of the processed material (3) from the bottom through the internal parts of the processed material (3); or
(extracts) the air from the processed material (3) or from separate parts of the processed material (3).

10. The champignon growing system according to claim 9, wherein:
the mentioned ventilated bottom (5) can be flat, concave, convex, of a regular or not regular form;
the form and amount of the mentioned aeration elements (6), ensuring the needed direction of the distributed localized flows, can differ.

11. The champignon growing system according to claim 9, wherein the mentioned shelving construction (2) can be a box, container, package, package system, air permeable mesh or other container of any form, considerably adjusted for the process of the mushroom growing.

12. The champignon growing system according to claim 9, wherein the aeration of the processed material (3) is implemented in various ways and the air flows can move in different directions, for example:
from the bottom to the top or from the top to the bottom,
where, when using the ventilated bottom (5), the air flows are directed from the bottom to the top or from the top to the bottom at a 90° angle or other angle that is technically implemented;
from the inside to the outside,
where the aeration element (8) having a form of a pipe is mounted into the formed mass (3) of the substratum/compost, through which the supplied air, entering inside the processed material (3), comes from the inside to the outside or vice versa, where the mentioned aeration element (8) having a form of a pipe can be arranged in different ways, for example, vertically, horizontally or other way;
or in other technically available ways.

13. A method of the champignon growing, comprising the usage of the champignon growing system, wherein the champignon growing system is in accordance with claim 9.

14. The method according to claim 13, wherein using the active localized aeration system (4) for the processed material (3), it ensures the temperature control in the processed material (3) or in a separate part/place of the processed material.

15. The method according to claim 13, wherein the method can be applied for any cultivated mushroom growing, for example for: champignons, oyster mushrooms (Pleurotus Ostreatus), Enoki, Bruno Shimeji, Maitake, Erengyii, Shi-take and other cultivated mushrooms, where the amount of the air (oxygen) and/or temperature are to be controlled during the aeration of the compost/substratum (growing medium) of the growing process.

16. The method according to claim 13, wherein using the mentioned active localized aeration system (4), the excess heat is collected from the compost, which can later be used for drying the substrata and preparing biofuel, heating the same or other premises, cooling the same or other premises and converting to electric power.

17. The champignon growing system according to claim 10, wherein the mentioned shelving construction (2) can be a box, container, package, package system, air permeable mesh or other container of any form, considerably adjusted for the process of the mushroom growing.

18. The champignon growing system according to claim 10, wherein the aeration of the processed material (3) is implemented in various ways and the air flows can move in different directions, for example:
from the bottom to the top or from the top to the bottom,
where, when using the ventilated bottom (5), the air flows are directed from the bottom to the top or from the top to the bottom at a 90° angle or other angle that is technically implemented;
from the inside to the outside,
where the aeration element (8) having a form of a pipe is mounted into the formed mass (3) of the substratum/compost, through which the supplied air, entering inside the processed material (3), comes from the inside to the outside or vice versa, where the mentioned aeration element (8) having a form of a pipe can be arranged in different ways, for example, vertically, horizontally or other way;
or in other technically available ways.

19. The champignon growing system according to claim 11, wherein the aeration of the processed material (3) is implemented in various ways and the air flows can move in different directions, for example:
from the bottom to the top or from the top to the bottom,
where, when using the ventilated bottom (5), the air flows are directed from the bottom to the top or from the top to the bottom at a 90° angle or other angle that is technically implemented;
from the inside to the outside,
where the aeration element (8) having a form of a pipe is mounted into the formed mass (3) of the substratum/compost, through which the supplied air, entering inside the processed material (3), comes from the inside to the outside or vice versa, where the mentioned aeration element (8) having a form of a pipe can be arranged in different ways, for example, vertically, horizontally or other way;
or in other technically available ways.

20. The method of the champignon growing, comprising the usage of the champignon growing system, wherein the champignon growing system is in accordance with claim 10.

21. The method of the champignon growing, comprising the usage of the champignon growing system, wherein the champignon growing system is in accordance with claim 11.

22. The method of the champignon growing, comprising the usage of the champignon growing system, wherein the champignon growing system is in accordance with claim 12.

23. The method according to claim 14, wherein the method can be applied for any cultivated mushroom growing, for example for: champignons, oyster mushrooms (Pleurotus Ostreatus), Enoki, Bruno Shimeji, Maitake, Erengyii, Shi-take and other cultivated mushrooms, where the amount of the air (oxygen) and/or temperature are to be controlled during the aeration of the compost/substratum (growing medium) of the growing process.

24. The method according to claim 14, wherein using the mentioned active localized aeration system (4), the excess heat is collected from the compost, which can later be used for drying the substrata and preparing biofuel, heating the same or other premises, cooling the same or other premises and converting to electric power.

25. The method according to claim 15, wherein using the mentioned active localized aeration system (4), the excess heat is collected from the compost, which can later be used for drying the substrata and preparing biofuel, heating the same or other premises, cooling the same or other premises and converting to electric power.
